(19) United States
(12) Patent Application Publication
(10) Pub. No.: US 2019/0327086 A1
(43) Pub. Date: Oct. 24, 2019

(54) RECIPROCAL DATA MIRROR SYSTEM AND METHOD OF DATA SECURITY

(71) Applicant: Bartosz Slowik, Zarow (PL)

(72) Inventor: Bartosz Slowik, Zarow (PL)

(21) Appl. No.: 16/389,712

(22) Filed: Apr. 19, 2019

Related U.S. Application Data
(60) Provisional application No. 62/662,172, filed on Apr. 24, 2018.

(51) Int. Cl. H04L 9/08; H04L 9/32; H04L 29/06; H04L 9/30; H04L 9/14

(52) U.S. Cl. CPC H04L 9/0825; H04L 9/3221; H04L 63/0442; H04L 9/0894; H04L 9/14; H04L 9/085; H04L 9/3073

(57) ABSTRACT

An aspect of this invention performs offline validation/authorization/digital signature/encryption/decryption of internal data which can be used as storage of external data in the database system for external environment to determine whether data stored in device satisfies identified external transactional request. The offline data vault is not vulnerable to remote hacking. The invention presented in this application combines the offline security with the online environment in a new method of data transaction. The authorization method can be used both for push and pull system allowing communication between two or multiple users and back. This system can be utilized for peer to peer, person to machine and vice versa or machine to machine data transactions. Other than transaction the method allows physical data mirroring for recovery purposes as well as data storage, processing, and control over the user device. Reciprocal Data Mirror allows the user to view/edit/transact data without disclosing identity/private key to the online environment. The invention also allows-on demand encryption, wherein a user can easily grant and revoke access to the data.

### CROSS-REFERENCE TO RELATED APPLICATIONS

The present invention claims priority to U.S. Provisional Patent Ser. No. 62/662,172 filed on Apr. 24, 2018 entitled “a reciprocal data mirror system and method of data security”, the disclosure of which is hereby incorporated at least by reference.

### BACKGROUND OF THE INVENTION

### 1. Field of the Invention

The present invention relates generally to data security, but more particularly to a reciprocal data mirror system and method of data security.

### 2. Description of Related Art

Over the last few years, cybersecurity has become a growing concern. Ever increasing connectivity and the integration of the physical world with information technology (cyber-physical systems) has increased the surface for cybersecurity attacks, together with their potential impact. Data leaks at large and small enterprises are now commonplace. There are also increased occurrences of industrial espionage, attacks on critical infrastructure, ransomware attacks and theft of financial assets. A recent report via Gemalto®, suggests that in 2017, 2,6 billion data records were breached in 1,765 cybersecurity incidents. A number of high-profile data leaks, such as the recent Marriot data breach, have shown that organizations regularly fail at keeping end-user data safe. In fact, the Marriot breach shows that even companies relying on cryptography to protect their data suffer cyber-attacks.

It has, therefore, become very difficult for users to trust the security measures in charge of protecting their increasing number of digital assets. Digital assets may include identity data, access credentials, digitized real-world assets, credit card details, or any other piece of confidential information. One of the main reasons for the apparent lack of cybersecurity is that technologies used to protect data, such as cryptography is very complex to use, and many organizations simply fail at using these measures adequately. In addition, in the cases in which organizations make use of cryptography, they have to deal with the additional burden of key management. The Trusted Platform Modules (TPM) and Hardware Security Modules (HMS) of the prior art are meant to help organization leveraging cryptography securely but introduce complexity and are not very practical.

Furthermore, in many cases, the security of any data item is directly anti-proportional to its accessibility and usability of highly secure systems is usually poor. This leads to certain risks being accepted, in order to improve the user experience.

An alternative approach to trusting remote organizations with user data is placing control and responsibility of data security with the data owner, meaning the asset is secured by the end-user. However, end-users are seldom trained in cybersecurity and their own devices might even be more vulnerable than hosted services. Even users experienced in cryptography often forego best practice guidelines, in favor of data accessibility and ease of use.

Backing up cryptographically secured data correctly is a challenge and once cryptographic credentials are lost, access to digital assets may be irrevocably lost. As an example, at the end of 2017, a study concluded that between 17 and 23% of existing Bitcoins had already been lost, mainly due to key loss. From this point of view, it may actually be safer to use hosted storage systems with appropriate backup facilities. Thus, securing digital assets efficiently is difficult, due to the complexity of current cryptographic solutions. They are also not user-friendly, which leads to poor practice and places digital assets at risk.

Yet further, the current methods of transmitting data alloy only a cold storage of data which cannot be processed in an online environment without a risk of the information being hacked. In an open and interconnected online environment security is vulnerable, and the threat of being hacked is increasing with the growth of online environment. Currently, there are no efficient ways to connect offline security with online accessibility, as any data stored at devices which are connected to the Internet are vulnerable to attacks. On the other hand, the cold storage of data does not allow external communication other than physical channel which is not as efficient as online data transaction. In encryption the private/secret key needed for decoding data can be hacked providing not only wide access to the information but also allowing the hacker to manipulate cloud stored data on behalf of the key owner. Consequently, the invention presented in this application combines the offline security with the online environment in a new method of data transaction.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention a data security system is provide, comprising a physical air-gapped data vault having private and isolated key storage configured to store at least one of a private key, key material, or pre-key; a unidirectional network connected to the physical air-gapped data vault, wherein the unidirectional network is configured to send or receive data; and, an untrusted data gateway connected to the unidirectional network enabling: encryption, message transmission; message origin verification; authentication; physical representation of data; digital fingerprint calculations; and zero-knowledge computations.

In one embodiment, wherein the zero-knowledge computations are processed in an air-gapped environment such that only the outcome or variable of the zero-knowledge computations are sent back to the unidirectional network. In one embodiment, the unidirectional network is a first unidirectional network and a second unidirectional network, wherein the first unidirectional network is configured to send or broadcast, and the second unidirectional network configured to receive. In one embodiment, the physical representation of data is in the form of a text message, QR code, image, photon, programming language sequence, binary sequence, or electronic frequency. In one embodiment, the physical air-gapped data vault is configured to perform the following functions: generation of key pair; receiving request of matching key pair; validating; encrypting data; message signature verification, key and secret storage, and decrypting data.

In another aspect of the invention, an on demand access management and authorization system is provided, comprising at least three connected devices including a data host, a proxy, and a data owner having data; an initial key material having a value, wherein the initial key material is stored among the data host, the proxy, and the data owner, such that the data owner is granted or revoked access via a shared secret cryptography on demand; and an end user having a computing device executing software configured to provide the initial key material via the proxy to be matched with the data host, wherein if the value is provided correctly by the data host, the proxy, and the data owner, the data may be decrypted. Initial key material, in the context of this paper, refers to a pre-key, a key derivation seed, and derived keys, or any other key material from which cryptographic keys can be generated. In one embodiment, the initial key material among the data host, the proxy, and the data owner, is encrypted individually. In one embodiment, the proxy does not host any data, but stores the initial key material. In one embodiment, the initial key material at the end user is stored at an enclave via a cryptography algorithm.

In one embodiment, the end user provides authorization by a prompt response via the software to decrypt the data for a predetermined period of time, wherein at the end of the predetermined period of time access is revoked. In one embodiment, the software is a website or a mobile application.

In another embodiment, a video streaming and viewing system in asymmetric cryptography having a split private key is provided, comprising a camera connected to the physical air-gapped data vault, wherein the physical air-gapped data vault is configured to perform encryption, wherein the encrypted data is channeled through the unidirectional network, such that that the encrypted data is decrypted and viewed by a second physical air-gapped data vault having a corresponding private key to facility the decryption.

In another embodiment, a connected device comprising the public key is provided, wherein the connected device is configured to send a data transaction request to the different air-gapped nodes such that if more than one of the different air-gapped nodes signed the data transaction with the public key and replicated private key the data transaction request is successfully established. In one embodiment, the physical air-gapped data does not store data and the different air-gapped nodes only stores the replicated private key. In one embodiment, a private key of the private keys in the physical air-gapped data vault corresponds to a public key, wherein the private key is replicated amount different air-gapped nodes.

In yet another aspect of the present invention a method is provided, comprising steps (a) offline data is encrypted in an offline data vault; (b) the encrypted data is sent to a reciprocal data mirror of a receiver; (c) the reciprocal data mirror receives the encrypted data and transmits the data to an offline device; (d) the data reaches the receiver, wherein an offline data vault performs verification of the receiver via a verification method; and,(e) the decoded data is secured in the offline data vault by the receiver.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a diagram illustrating two data vaults or connected offline systems according to an embodiment of the present invention;

FIG. 2 is a diagram illustrated an offline system according to an embodiment of the present invention;

FIG. 3 is a diagram illustrated an offline system according to an embodiment of the present invention;

FIG. 4 is flow diagram illustrating physical access to a cold storage unit according to an embodiment of the present invention;

FIG. 5 is a flow diagram of a data security method according to an embodiment of the present invention;

FIG. 6 is a flow diagram illustrating a reciprocal data mirror connector for AI and autonomous driving according to an embodiment of the present invention; and,

FIGS. 7 illustrates the system comprising a physical air-gapped data vault having private and isolated key storage configured to store of the following (but not limited to): private key/key material/pre-key; a unidirectional network connected to the physical air-gapped data vault, wherein the unidirectional network is configured to send or receive data; and, an untrusted data gateway connected to the unidirectional network according to an embodiment of the present invention.

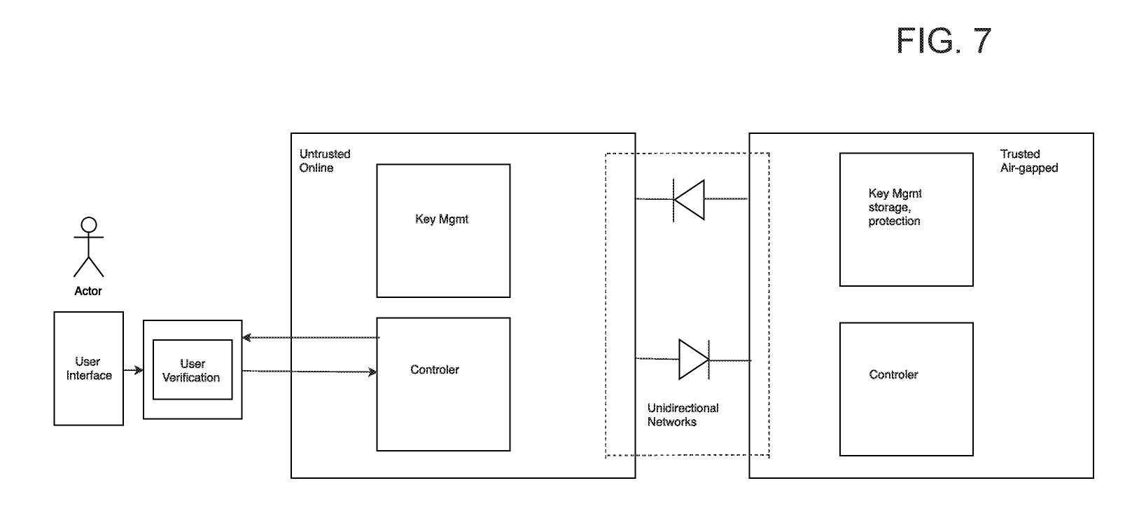

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a method of data security against intrusion, theft, and hacking. It is a particular advantage of the present invention to provide a safe mode between offline and online environments providing users with online accessibility and offline security.

The word “a” is defined to mean “at least one.” The word “Syllab” is defined to mean “the present invention.” The word “air-gapped” is defined to mean “offline.” The word “Reciprocal data mirroring” is defined to mean “that the data in which the system is managing is replicated over several different nodes and cloud storage systems.” The word “authentication” is defined to mean “providing the right or matching data with elements required for decryption, such as keys and initial key materials (IKM).” The words “unidirectional network” is defined as “a device allowing data to travel only in one direction.” The terminology includes the words above specifically mentioned, derivatives thereof, and words of similar import.

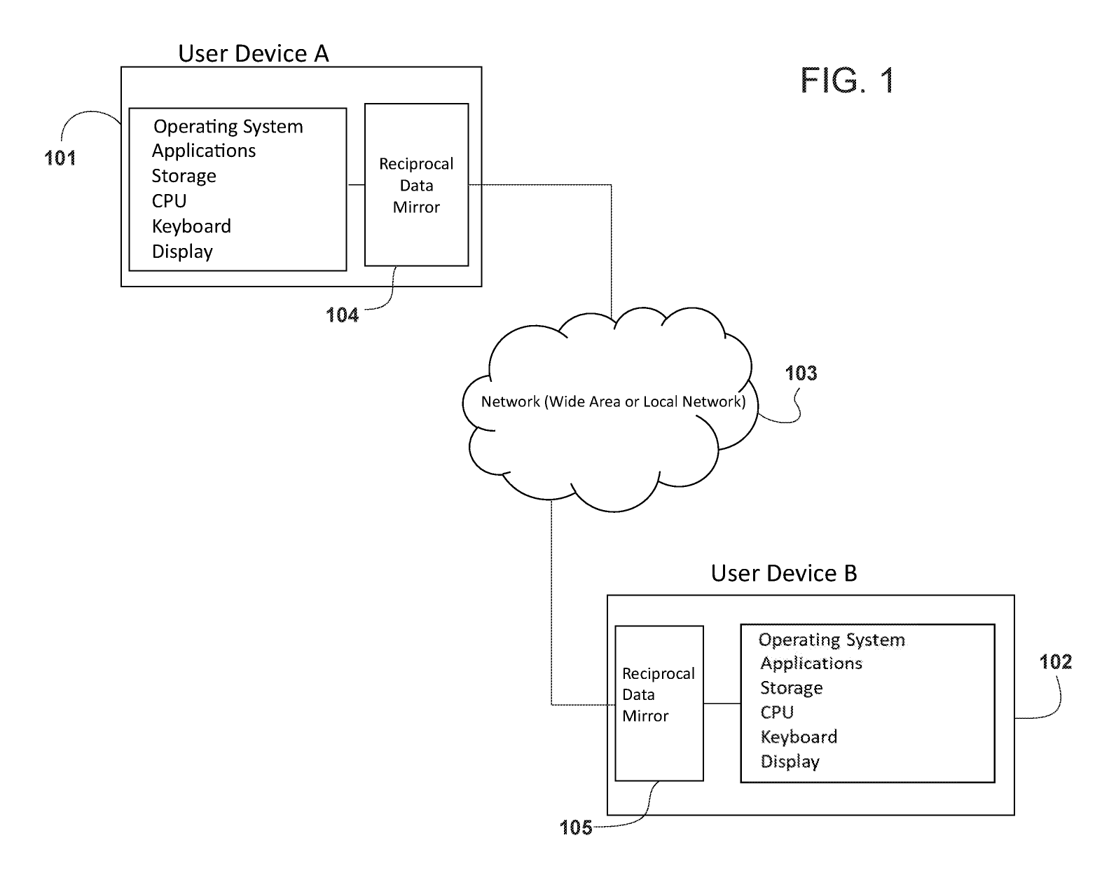

FIG. 1 is a diagram illustrating two data vaults or connected offline systems according to an embodiment of the present invention. In one embodiment, the offline systems 101 (User Device A) and 102 (User Device B) are connected via a local or wide area network 103. Each system comprises common system components well known in the art, including but not limited to, operating systems, application, storage, CPU, keyboard, and display. In one embodiment, each system includes a Reciprocal Data Mirror (RUM) 104 and 105 enabling data transaction between systems.

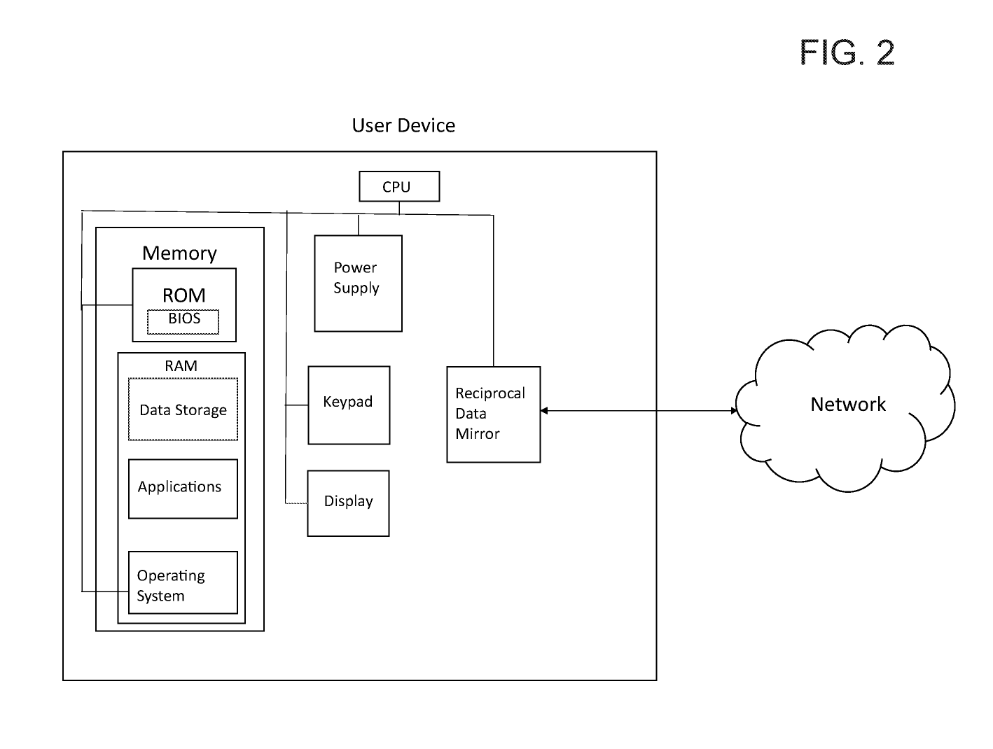

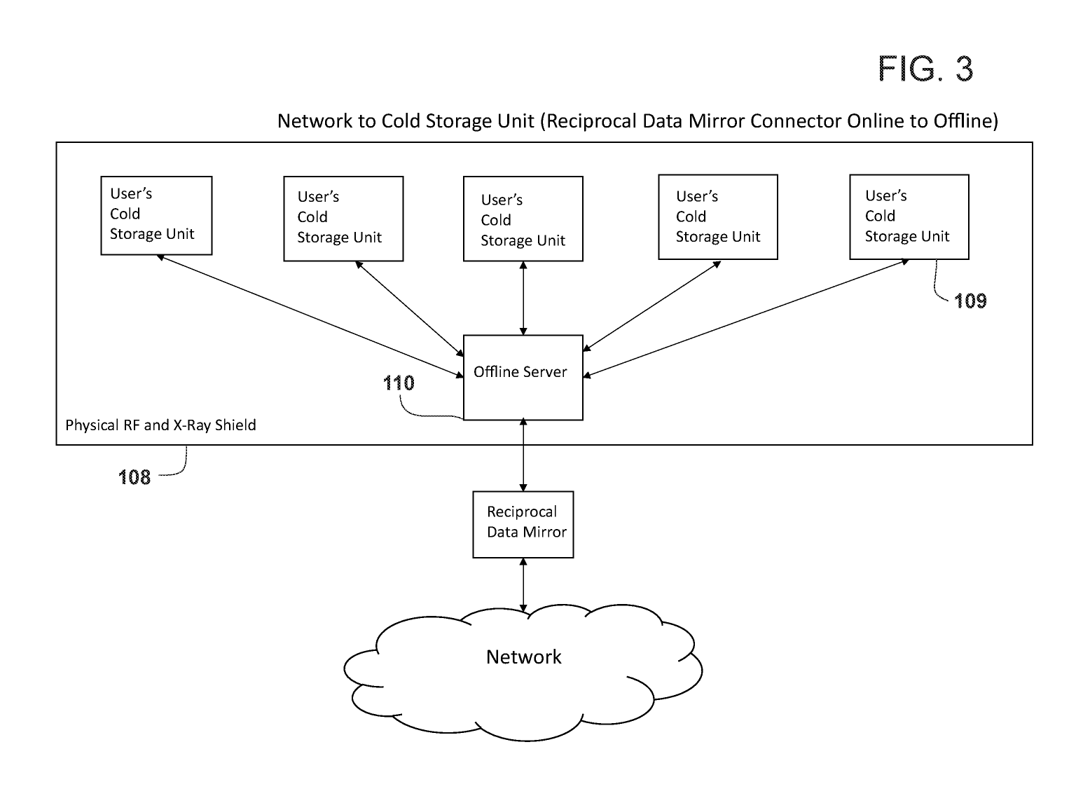

Further details of an offline system (101 or 102) are shown in FIGS. 2-3. In one embodiment, the offline systems may include EMC/RF blocking or X-ray shielding 108. It is a particular advantage of the present invention to provide a RDM providing a bridge between a network connection and a user device, e.g. User Device A or B, enabling the offline control of the user device and access to the network, where all data flow is passed through the RMD. In one embodiment, at least one storage unit 109 connected to an offline server 110 is connected to an RDM in a network enabling access or deposits to the data. This configuration secures the storage of data in the at least one storage unit, as the data is physically shielded from the external environment, as the only way to access the data is via the RDM or physical access by opening the shielded environment.

In one embodiment, data is created by User Device A 101 and is first encrypted in offline environment using Public Key Infrastructure(PKI) (private key is used behind RDM on the User A side). Next, encrypted data is passed through RDM 104 and the data is sent over network 103 to User Device B 102. In one embodiment, the receiving party (User Device B) is also using a RDM 105 to receive the data which is then decrypted in the offline environment of User B device. In alternative embodiments, an established connection allowing stream of data is transacted by the users. The RDM infrastructure can allow multiple nods, and users.

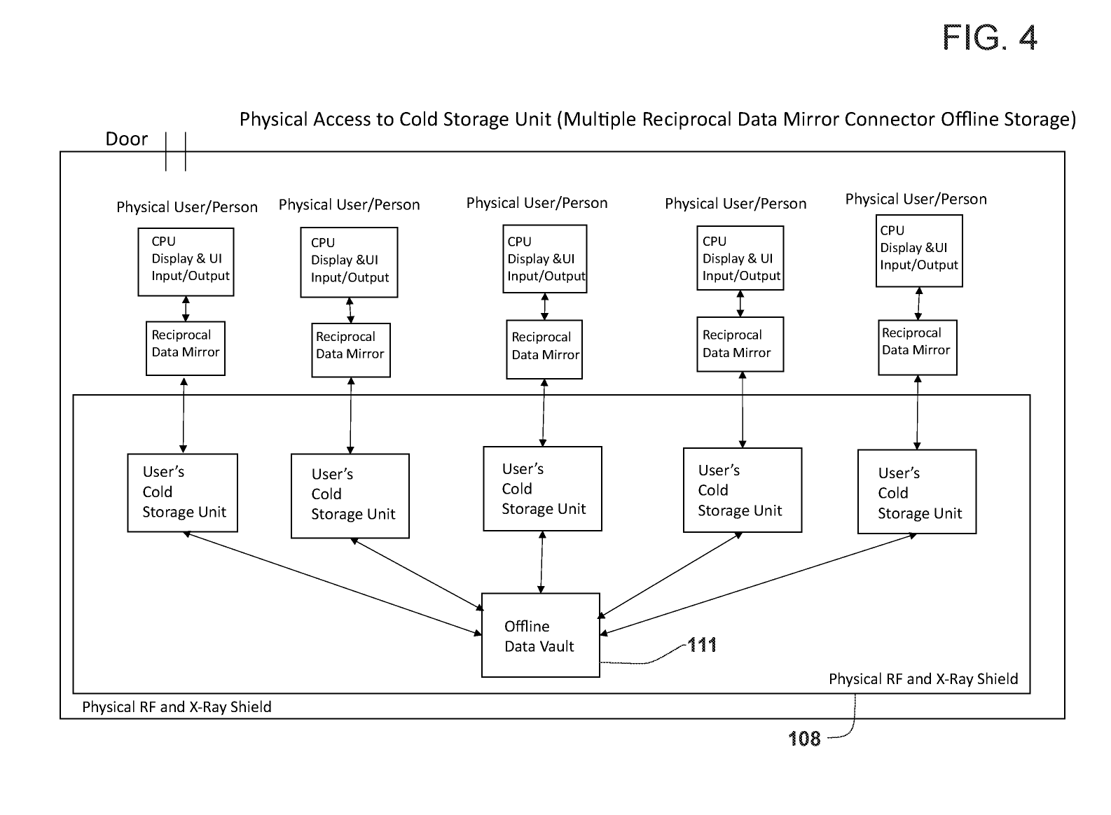

FIG. 4 is flow diagram illustrating physical access to a cold storage unit. Referring now to FIG. 4, multiple reciprocal data mirror (RDMs) can be used to access data in cold storage units. As previously described, the physical embodiment is shielded from RF via shield 108. A user must physical access the data and overcome physical verification methods, including but not limited to biometrics, PIN, or similar access methods. In one embodiment, an offline data vault 111 is located in the same enclosed environment. In alternative embodiments, the offline data vault is located in another physical location. In some embodiments, data is distributed amount different offline data vaults and accessed via RDMs.

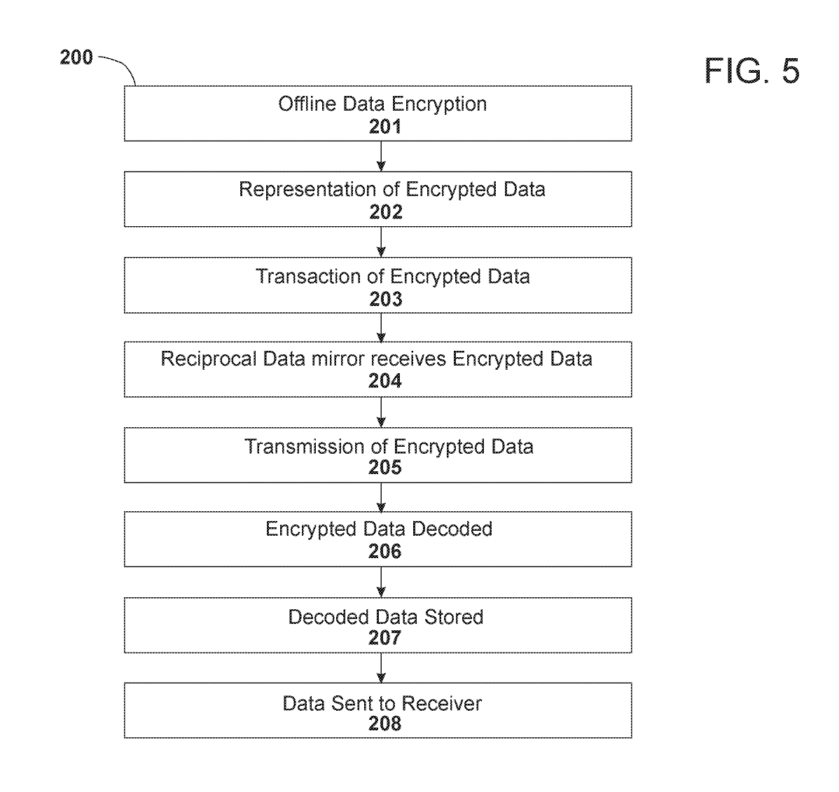

FIG. 5 is a flow diagram of a data security method 200 according to the present invention. Now referring to FIG. 5, the method comprises the steps shown. In step 201, offline data is encrypted in an offline data vault (via offline system 101 (User Device A); FIG. 1). Preferably, a cryptographic hash function is applied to the offline data; however any form of data encryption may be used.

In step 202, the encrypted data is physically represented in the form of a text message, QR code, image, photon, programming language sequence, binary sequence, electronic frequency, or other form.

In step 203, the encrypted data is sent to a reciprocal data mirror of a receiver, e.g. User Device B to a reciprocal data mirror.

In step 204, the reciprocal data mirror receives the encrypted data and transmits the data to an offline device (step 205). In one embodiment, the reciprocal data mirror includes an additional verification or security method. In one embodiment, the offline device includes a private key required for data decryption. The transmission process is done via physical scanning, recording, optical reciprocity, or any other method of reading the data.

In step 206, the data reaches the receiver, e.g. User Device B, wherein an offline data vault performs verification of the receiver via a verification method, such as a PIN or biometrics test. Upon successful validation, the data is decoded using a private key which is stored in an offline data vault or generated via the verification method. In one embodiment, the user can edit and interact with the decoded data and/or store it for future use behind the RDM.

In step 207, the decoded data may be authorized to be secured in the offline data vault by the receiver. In one embodiment, the data may be stored as encrypted data.

In step 208, in one embodiment, the data may be transmitted via the RDM back to an online environment in encrypted form and sent back to User Device A or another receiver.

By using the method described above, the private key is not exposed via an online channel, thus protecting the private key and encrypted date as opposed to current systems which allow open connections making data vulnerable to remote hacking. In current systems, the data has to be processed offline to be protected, which requires disabling the Internet connection and storing the data on a peripheral or external hard disk. However, this system is not interactive for the user, as the cold storage doesn't allow the user to process the data online without exposing the data risk of hacking. The present invention provides the user with a possibility to transact data across different online channels without exposing the data, wherein any manipulation of the data is done by the user in an offline environment. The present invention is a much improved security of data over current systems. For instance, if an intruder gets access to the private key, remote hacking would still be disabled because the control system would be behind the reciprocal data mirror in an offline secure environment. In order to access the data, the intruder would have to make a physical assault in exact time/location of the user and force the person to unlock the encryption using private key and give access to the device. In this method the physical attack on an organization to steal private keys that are stored in cold storage or offline servers would not provide the intruders with the means to use these devices remotely during physical attack.

An example of the present invention is as follows; user A is using reciprocal data mirror hardware to process SH256 encrypted information regarding his transaction of cryptocurrency to user B. The encryption of the information is done offline at user A and it passes the RDM to enter the online environment which then is sent over online channel to user B. Next, user B receives the message in the online environment to pass through the RDM to the offline environment where the transaction is signed by User B to complete the transaction. Then, the data is encrypted and sent passing RDM to send to the cloud for verification. The computing facility also uses a RDM to read and verify user A and user B digital signatures to create a block which is then updated to the public ledger.

Various embodiments of this invention address remote tampering and leakage of the private data concerns. In the context of other media like audio following mixed-excitation linear prediction (MELP) or other secure encoding. The video encrypted streaming or recoding can be also transferred through the RDM for offline decoding and usage. The process of streaming the video would be possible with assumption of establishing a connection between two users in which data is being downloaded to the computer but decoded behind Reciprocal Data Mirror in a secure offline vault. The process of transferring data can be machine to machine in which the process can be automatic or predetermined by computation algorithms.

In another aspect of the invention, it is an object of the present invention to provide a platform for distributed computing and outsourcing storage and blocks of data across the network without a need to decode the information. For example, under the encrypted protocol, user A is transferring encrypted data throughout network using other devices within an online environment to transfer or store the packaged data to reach the RDM, wherein the data can be decoded and read. The blocks allow proof of stake, proof of work, proof of trust or any other verification methods. The block will be created upon successful signature of the user B triggers the creation of blocks. In this example, the cloud will only contain the encrypted data, and the decoding process will take place behind the RDM.

In one embodiment, a real time update of data would be possible using mirroring system, wherein the data would be manipulated by a user and updated to a network through a RDM. This can be achieved by parallel protocol. Current inventions of offline to online switch do not allow the data to be updated in real time. The user of the RDM would have access to the Internet (World Wide Web) via an encrypted channel and while using tools like online private network and the RDM, the user would be able to update the content in the offline environment and online environment at the same time. The present invention allows the possibility to share data across the network creating distributed computing and storage.

In the present invention, the CPU, operating system, data stores, BIOS, hard drive is physically disconnected from the connection to the Internet. In some embodiments, other means of transmission and can be also physically shielded from electromagnetic interference/compatibility by using RF/UV/X-ray physical blockers. As previously described, the connection between the network interface unit and the processing unit is protected by a reciprocal data mirror (RDM) which separates the offline and online environments. This can be achieved by using distinct parallel systems, wherein the two parallel systems are linked via RDMs. The online environment is only processing the encrypted data while the RDM is automatically scanning and updating the data in real time on the offline side. Therefore, the data cannot be hacked unless there is a physical theft of existing node that is connected to the RDM. For example, in the dynamics of HTML the current language the methods of GET, PATCH, PUT, POST, and DELETE allow users to easily manipulate the data in the open source environment. The firewall only blocks the requests from the unidentified and filters established data transactions. The user private network allows a proxy server to create new IP address, but still connects the data to the Internet. In the present invention, the proxy server acts like data ledger where the encrypted data is stored, and everyone in the network can view the data; however, the owners of private key might encode the data. The main purpose of the proxy server in this network protected by RDM is to automatically verify if User A information matches request and is correctly transferred to User B, creating a record of the data transaction and uploading it to the cloud.

In one embodiment, the present invention can follow the structure of asymmetric cryptographic standard (or any other cryptographic methods like symmetric, ring signatures, zero knowledge proof protocol, including existing standards DSA, RSA, ECDSA or others) in assumption of asymmetric cryptographic standard: Private Key, Public Key, and digital signature. The transacted data might be sent through as an encrypted hash function (example SH256), cipher text, or any other form throughout Internet or other channels like datacasting, LAN, Ethernet. The data might be represented as text, QR code, bar code, image or photon, video/audio recording, sensory data, computer vision data, motion sensors data, high dimensional data, and other means of representing the data. The offline encryption of data which can be generated in a single data vault or offline Ethernet which after the encryption is transmitted via the mirror/reciprocal data mirror.

An offline data processing and storage device in principle enables data to be organized, added, deleted, and updated according to user's request. The request can be processed in structured inquires of computer programming language (eg. SQL, Java, PHP, HTML) or software enabled to direct the request to the database within offline environment of the device.

Network server or a proxy server VPN might also be use the method to process and verify the data transactions. If there is a need for large data stream can be achieved by datacasting in which the encrypted data which is made to the public by broadcasting and this data over several channels. This would allow large amount of data to be sent across different servers and the servers would use this method to decrypt the information via the Reciprocal Data Mirror.

In quantum computing, the physical mirror would allow data to be viewed and/or edited in a sate mode. Further developments of quantum cryptography will secure the channel; however, the private/secret key encoded in the photons might be exposed to external hacking. Therefore, the present invention will help to control and encode photons behind the secure reciprocal data mirror. In reciprocal data mirroring in quantum cryptography it refers to a mirroring way of transferring a photon from an online environment, and to a disconnected and shielded environment.

In one embodiment, the channel of data transaction might be also integrated with different protocols (other than standard TCP/IP, TLS, SSL, IPsec, DTSL, and others); for instance, this method would solve issue of exit node vulnerability in the onion router when the method would be implemented by the users. In this method the protocol might be utilized to create private protocol on the top of existing onion router protocol that would greatly enhance the security of the network. The original goal of creating the protocol for secure communication between military or corporate personnel could be enhanced by the reciprocal data mirror/reciprocal method. Each of the users in this private network would use a RDM as an exit node. If there would be a need to limit visibility of the traffic the reciprocal data mirror method could be utilized to direct/send the encrypted data over protocol in multiple data packets that the traffic analysis is harder to trace.

In another embodiment, the present invention may be used to eliminate online passwords which can be hacked remotely. The offline decryption would happen in secure offline environment, and the online content would be transmitted as encrypted information. This would enhance virtual private network using different IP addresses depending on sessions and transactions.

In other embodiments, in the centralized and decentralized databases, the present invention may be used for security, backup recovery, and monitoring of data (black box/whitebox, and others), as centralized databases are often target of remote hacking due to a magnitude of events which hacking the database might cause. The large quantities of data transactions run real-time updates throughout the servers creating data which includes often all real-life events and failed attempts. This storage method requires large computing power to extract the information. This method of monitoring the data can be tailored to specific needs of the user. For example, if a bank needs to store financial statements of the users the method of storing information behind the reciprocal data mirror the data can be extracted from the servers in the real-time online data stream and updated to offline storages across different locations and offline nodes via reciprocal data mirror.

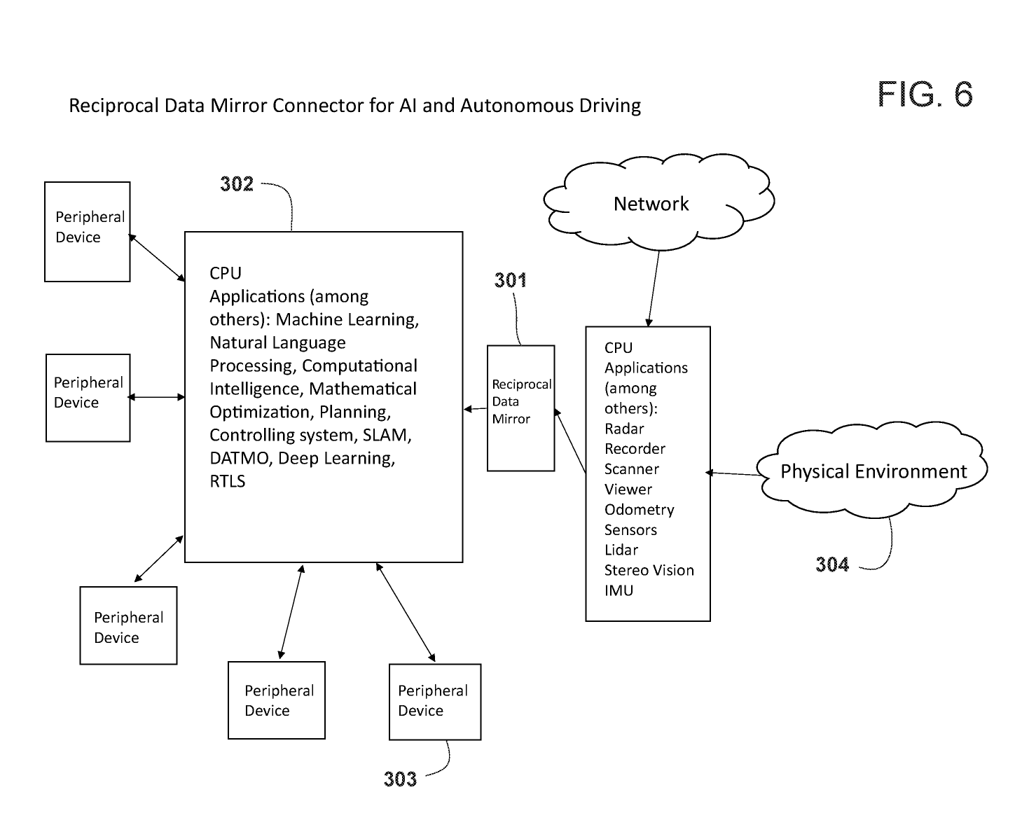

FIG. 6 is a flow diagram illustrating a reciprocal data mirror connector for AI and autonomous driving. Referring now to FIG. 6, a reciprocal data mirror (RDM) 301 may be advantageous used in applications using control unit devices, such as AI and autonomous driving. The RDM eliminates the threat of remote hacking to control unit 302 by an intruder, while still allowing a verified user to access network data. The control unit can command and control peripheral devices 303 without a risk of intrusion. In one embodiment, the RDM may be utilized for transacting data from a physical environment 304 to the control unit.

In the autonomous driving and network connected vehicles (or any transportation object) the risk of hacking cars will grow along with the growth of the industry. The present invention would eliminate the risk of hacking the car and taking control over the driving unit. Driving conditions extracted from online/GPS/radar network as well as offline sensory information (odometry, computer vision) can be managed by the RDM transaction. It is a particular advantage of the present invention to prevent the risk of remotely taking control over the vehicle/transportation object. In this method the decision-making process on what to do with the device is in the hands of the user not a hacker while still having access to the network.

The present invention is also useful in other embodiments and applications. For instance, in the current cybersecurity system, healthcare data and pharmaceutical data is exposed to remote hacking. Hacking and changing chemical formula in drug manufacturing facility is a potential threat that would have disastrous effect. In the time of progress in automation of production facilities the interconnected online environment is vulnerable to hacking. The present invention would prevent the remote intrusion into the production flow. Hospitals are concerned over data breach of their patients. Thus, advantageously sensitive information like DNA or patients' medical history can be stored behind the RDM.

In the interconnected online environment, there is growing threat of remotely taking control over servers, networks, databases, and manipulating the information or causing electricity shutdown. It is an object of the present invention, to provide a secure environment which can be implemented across the industries which are the most vulnerable to hacking including but not limited to, financial institutions, military, governments, corporations in healthcare, pharmaceutical, and others. Unlike the firewall, a RDM is not a monitoring device or filter of data, but a bridge between offline and online environment. In the present invention, software, firmware, and hardware create this bridge which can be managed by a user or machine. Further, with developments of machine learning algorithms, the present invention can create an independent unit which can be remotely hacked or controlled. The physical scanning and reading data from a physical environment can also be applied to record, receive, encrypt, and upload it to the network. By establishing a connection between the users, an established consensus on how data is created, edited, and transmitted is possible. A permission system can have several different parties by creating distributed digital signatures system using reciprocal data mirror which would trigger events. Each of the parties would have to agree to the event to occur, for example, a power plant shutdown or electronic money transfer between banks.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, the physical air-gapped data vault may be a hardware security module (HSM).

What is claimed is:

1. A data security system comprising:
a physical air-gapped data vault having private and isolated key storage configured to store at least one key selected from the group essiential consisting of: a private key, key material, and a pre-key;
a unidirectional network connected to the physical air-gapped data vault, wherein the unidirectional network is configured to send or receive data; and,
an untrusted data gate connected to the unidirectional network enabling:
encryption;
message transmission;
message origin verification;
authentication;
physical representation of data;
digital fingerprint calculations; and,
zero-knowledge computations.

2. The data security system of claim 1, wherein the zero-knowledge computations are processed in an air-gapped environment such that only the outcome or variable of the zero-knowledge computations are sent back to the unidirectional network.

3. The data security system of claim 1, wherein the unidirectional network is a first unidirectional network and a second unidirectional network, wherein the first unidirectional network is configured to send or broadcast, and the second unidirectional network configured to receive.

4. The data security system of claim 1, wherein the physical representation of data is in the form of a text message, QR code, image, photon, programming language sequence, binary sequence, or electronic frequency.

5. The data security system of claim 1, wherein the physical air-gapped data vault is configured to perform the following functions:
generation of key pair;
receiving request of matching key pair;
validating;
encrypting data;
message signature verification;
key and secret storage; and,
decrypting data.

6. The data security system of claim 1, further comprising a video streaming and viewing system in asymmetric cryptography having a split private key comprising a camera connected to the physical air-gapped data vault, wherein the physical air-gapped data vault is configured to perform encryption, wherein the encrypted data is channeled through the unidirectional network, such that that the encrypted data is decrypted and viewed by a second physical air-gapped data vault having a corresponding private key to facility the decryption.

7. The data security system of claim 1, wherein a private key of the at least one key in the physical air-gapped data vault corresponds to a public key, wherein the private key is replicated among different air-gapped nodes.

8. The data security system of claim 7, further comprising a connected device comprising the public key, wherein the connected device is configured to send a data transaction request to the different air-gapped nodes such that if more than one of the different air-gapped nodes signed the data transaction with the public key and replicated private key the data transaction request is successfully established.

9. The data security system of claim 7, wherein the physical air-gapped data does not store data and the different air-gapped nodes only stores the replicated private key.

10. An on demand access management and authorization system comprising:
at least three entities including a data host, a proxy, and a data owner having data;
an initial key material having a value, wherein the initial key material is stored among the data host, the proxy, and the data owner, such that the data owner is granted or revoked access via a shared secret cryptography on demand; and,
an end user having a computing device executing software configured to provide the initial key material via the proxy to be matched with the data host, wherein if the value is provided correctly by the data host, the proxy, and the data owner, the data may be decrypted.

11. The on demand access management and authorization system of claim 10, wherein the initial key material among the data host, the proxy, and the data owner, is encrypted individually.

12. The on demand access management and authorization system of claim 10, wherein the proxy does not host any data, but stores the initial key material.

13. The on demand access management and authorization system of claim 10, wherein the initial key material at the end user is stored at an enclave via a cryptography algorithm.

14. The on demand access management and authorization system of claim 13, wherein the end user provides authorization by a prompt response via the software to decrypt the data for a predetermined period of time, wherein at the end of the predetermined period of time access is revoked.

15. The on demand access management and authorization system of claim 13, wherein the software is a website or a mobile application.

16. A method is provided comprising steps:
(a) offline data is encrypted in an offline data vault;
(b) the encrypted data is sent to a reciprocal data mirror of a receiver;
(c) the reciprocal data mirror receives the encrypted data and transmits the data to an offline device;
(d) the data reaches the receiver, herein an offline data vault performs verification of the receiver via a verification method;
(e) the decoded data is secured in the offline data vault by the receiver;
(f) an online cryptographic session is established between user, data host, proxy, where
(g) the proxy (RDMS) stores the key material offline;
(h) the user and data host store the key material online; and,
(i) encryption, decryption, message origin verification, digital signature, authentication, message transmission, zero-knowledge computation only occurs if all three materials provided by user, data host, and proxy match
